(19) United States
(12) Patent Application Publication
(10) Pub. No.: US 2011/0119504 A1
(43) Pub. Date: May 19, 2011

(54) CONTENT PROTECTING METHOD, CONTENT REPRODUCING APPARATUS, AND PROGRAM

(76) Inventor: Takuya NISHIMURA, Osaka (JP)

(21) Appl. No.: 12/817,460

(22) Filed: Jun. 17, 2010

(30) Foreign Application Priority Data
Nov. 18, 2009 (JP) 2009-262708

(51) Int. Cl. G06F 12/14; H04L 9/00

(52) U.S. Cl. 713/193; 380/277

(57) ABSTRACT

A content reproducing apparatus includes a viewing expiration time determining unit which determines lapse of a viewing expiration time, a decryption key temporary storage unit which temporarily stores a decryption key, a decryption key moving unit which moves the decryption key from a recording medium to the decryption key temporary storage unit and returns the decryption key onto the recording medium, and a content protection control unit which controls the movement and the return of the decryption key. The content protection control unit performs control to move, when a reproduction start instruction is received, the decryption key from the recording medium to the decryption key temporary storage unit, return, when the reproduction of the content ends, the decryption key onto the recording medium when the viewing expiration time has not lapsed, and not return the decryption key onto the recording medium if the viewing expiration time has lapsed.

### FIELD OF THE INVENTION

The present invention relates to a content reproducing apparatus, a content protecting method, and the like for reproducing encrypted content written in a detachable recording medium together with viewing expiration time information.

### BACKGROUND OF THE INVENTION

In recent years, according to the development of the Internet, techniques for downloading and reproducing movies, music, and the like are becoming popular. A large number of services for downloading contents from servers, which perform content distribution of movies, music, and the like, to PCs, AV apparatuses, cellular phones, and portable apparatuses through networks are provided.

As forms of such content delivery services, there are content sales of a sell-once type in which a user can permanently view purchased content and rental sales in which a user can view downloaded content within a limited viewing expiration time.

In typical rental sales of a download type, a content dealer, which supplies content, operates a content server and a DRM server and a content receiver on a viewer side downloads encrypted rental content from the content server and acquires a decryption key for the encrypted content and viewing conditions for the content from the DRM server. The viewing conditions for the content include viewing expiration time information concerning a term in which viewing of the content is permitted and a copying condition for the content.

When the content receiver reproduces rental content, the content receiver refers to viewing expiration time information designated by the DRM server, starts reproduction of the content if a viewing expiration time has not lapsed, and carries out deletion of the content if the viewing expiration time has lapsed. In some case, the content receiver writes out the rental content to a detachable recording medium such as an SD card together with the viewing expiration time information. In this case, when a reproducing apparatus for the SD card attempts to reproduce rental content or when the reproduction for the content is ended, the reproducing apparatus deletes the content if a viewing expiration time for the content has lapsed. As a method of reproducing content with viewing expiration time of this type, for example, there is a method described in Patent Document 1 (Japanese Patent Application Laid-Open No. 2007-257616).

FIG. 4 is a block diagram of a conventional content download system including a content receiver which writes out downloaded rental content to an SD card together with viewing expiration time information.

A content receiver 502 accesses a content server 500 and a DRM server 501 operated by a content dealer via a network (not shown). In carrying out download of rental content separately designated by a user, the content receiver 502 downloads encrypted content 115 from the content server 500 and acquires a content key 505 for decryption of the encrypted content 115 and viewing expiration time information 600 for the encrypted content 115 from the DRM server 501.

When the content receiver 502 itself carries out reproduction of the content, after determining whether a viewing expiration time for the encrypted content 115 has not lapsed, if the viewing expiration time has not lapsed, the content receiver 502 decrypts the encrypted content 115 using the content key 505 and reproduces the content.

A case in which content as rental content received by the content receiver 502 is written out to an SD card 102 and viewing is performed by a content player 200 different from the content receiver 502 is explained below.

The content receiver 502 decrypts, in a DRAM decrypting unit 507, the encrypted content 115 using the content key 505, carries out, in a CPS encrypting unit 508, re-encryption in a CPRM (Contents Protection for Removal Media) format which is a CPS (Contents Protection System) for an SD card, writes a re-encrypted content 103 in the SD card 102, and writes a title key 104 used for decryption of a CPS code in association with the encrypted content 103. A viewing condition converting unit 509 of the content receiver 502 converts a viewing condition for the encrypted content 115 received from the DRM server 501 into the CPS format and records the converted viewing condition as viewing expiration time information 105 for the CPS in the SD card 102 in association with the encrypted content 103.

FIG. 5 is a block diagram of a player, which reproduces content recorded in an SD card, for explaining a conventional method of reproducing content with viewing expiration time.

When a reproduction control unit 112 in the player 200 receives a content reproduction instruction (not shown) from a user, the reproduction control unit 112 instructs a viewing expiration time determining unit 107 to read out the viewing expiration time information 105 for the encrypted content 103, which is a reproduction target, from the inserted SD card 102 and determine whether a viewing expiration time has lapsed.

The viewing expiration time determining unit 107 reads out the viewing expiration time information 105 for the encrypted content 103 from the SD card 102 and compares the viewing expiration time information 105 with current time acquired from a clock 101 to thereby determine whether the viewing expiration time has lapsed and returns a determination result to the reproduction control unit 112.

In this case, when the viewing expiration time has lapsed, the viewing expiration time determining unit 107 deletes the encrypted content 103, the viewing expiration time information 105, and the title key 104 for the encrypted content 103 on the SD card 102.

When the viewing expiration time has not lapsed, the reproduction control unit 112, which has received the determination result from the viewing expiration time determining unit 107, instructs a key readout unit 201 to set the title key 104 on the SD card 102 in a content decrypting unit 108 and instructs the content decrypting unit 108 to start reproduction of the content. The content decrypting unit 108, which has received this instruction, reads out the encrypted content 103 on the SD card 102 and outputs plaintext content, which is a result of decrypting the encrypted content 103 with the title key 104, to a decoder 109. The decoder 109 converts the input content into an AV signal and outputs the AV signal as an AV output 110.

When the reproduction control unit 112 receives a reproduction stop instruction (not shown) from the user or the reproduction of the content reaches the end of the content and the reproduction control unit 112 ends the reproduction of the content, the reproduction control unit 112 instructs the viewing expiration time determining unit 107 again to carry out the determination concerning whether the viewing expiration time has lapsed. When the viewing expiration time has lapsed at this point, the viewing expiration time determining unit 107 deletes the encrypted content 103, the title key 104, and the viewing expiration time information 105 on the SD card 102.

In this way, the content downloaded by the content receiver 502 and recorded in the SD card 102 is reproduced by the separate player 200.

All the disclosures of the Document 1 are cited in its entirety and thereby become an integral part hereof.

However, in the related art, there is a problem in that, when the user removes the SD card 102 from the player 200 without performing a reproduction stop instruction for content, encrypted content and a title key for decrypting the content, which should essentially be deleted, remain on the SD card 102.

Specifically, when the SD card 102 is removed from the player 200 without the reproduction stop instruction for content being performed, the SD card 102 leaves the control by the player 200 while viewing expiration time determination at the time of reproduction end and determination processing for content deletion incidental to the viewing expiration time determination cannot be carried out. Therefore, deletion processing for content, a viewing expiration time of which has lapsed at the time of reproduction end, cannot be executed.

For example, it is assumed that the viewing expiration time information 105 for the encrypted content 103 is until 19:00, Sep. 29, 2009 and the reproduction length of the encrypted content is two hours. When time of a reproduction instruction for the encrypted content 103 issued by the user is 18:30, Sep. 29, 2009, reproduction is started because the viewing expiration time has not lapsed. However, after content viewing for two hours, time should be 20:30, Sep. 29, 2009. Therefore, essentially, the encrypted content 103, the title key 104, and the viewing expiration time information 105 should be deleted from the SD card 102 at the time of the end of viewing. If a malicious user removes the SD card 102 from the player 200 without performing a reproduction stop instruction at a point when one hour fifty-nine minutes elapses from the start of the reproduction of the encrypted content 103, the encrypted content 103, the title key 104, and the viewing expiration time information 105 are kept recorded on the SD card 102 regardless of the fact that the viewing expiration time has lapsed at that point. Such an SD card 102 becomes a target of malicious analysis of a pirated content dealer or the like and causes illegal copied content distribution. Since the title key 104 remains on the SD card 102, a user reproduces content with an expired viewing expiration time by a program mistake of a player even if the user has no ill will. A viewing right contract granted to a content dealer by a content right holder is not observed. This causes prevention of wholesome content distribution.

In view of the problems of the conventional content reproducing apparatus, it is an object of the present invention to provide a content reproducing apparatus, a content protecting method, and the like which can prevent, when a viewing expiration time has lapsed during reproduction of content with viewing expiration time recorded on a recording medium, malicious analysis and wrong reproduction even if the recording medium is removed from a reproducing apparatus.

### SUMMARY OF THE INVENTION

The 1^{st} aspect of the present invention is a content protecting method when a recording medium in which an encrypted content involving a viewing expiration time and a decryption key for decrypting the content were recorded is inserted into a reproducing apparatus,

the content protecting method comprising:

a decryption key evacuation step of moving the decryption key from the recording medium onto the reproducing apparatus, from a time when the recording medium is inserted into the reproducing apparatus until the viewing expiration time lapses or until a predetermined period elapses after the viewing expiration time; and

a decryption key returning step of, when a predetermined event occurs, returning the decryption key onto the recording medium when the viewing expiration time has not lapsed or the predetermined period has not elapsed after the viewing expiration time and not returning the decryption key onto the recording medium when the viewing expiration time has lapsed or the predetermined period has elapsed after the viewing expiration time.

The 2^{nd} aspect of the present invention is the content protecting method according to the 1^{st} aspect of the present invention, wherein

the moving of the decryption key is copying the decryption key on the recording medium onto the reproducing apparatus and invalidating the decryption key on the recording medium, and

the returning of the decryption key is validating the invalidated decryption key on the recording medium.

The 3^{rd} aspect of the present invention is the content protecting method according to the 1^{st} aspect of the present invention, wherein,

in the decryption key evacuation step, the movement of the decryption key is executed when reproduction of the content is started.

The 4^{th} aspect of the present invention is the content protecting method according to the 1^{st} aspect of the present invention, wherein,

in the decryption key evacuation step, the movement of the decryption key is executed when the viewing expiration time lapses or the predetermined period elapses after the viewing expiration time.

The 5^{th} aspect of the present invention is the content protecting method according to the 1^{st} aspect of the present invention, wherein,

in the decryption key evacuation step, instead of performing the movement of the decryption key, the decryption key of the recording medium is invalidated when the viewing expiration time lapses or the predetermined period elapses after the viewing expiration time.

The 6^{th} aspect of the present invention is the content protecting method according to the 1^{st} aspect of the present invention, wherein

the predetermined event means that reproducing operation for the content is completed, the recording medium is removed from the reproducing apparatus after the completion of the reproducing operation, or a reproduction suspension instruction is received during the reproduction of the content.

The 7^{th} aspect of the present invention is the content protecting method according to the 1^{st} aspect of the present invention, wherein,

in the decryption key returning step, if the viewing expiration time has lapsed when the predetermined event occurs, the decryption key on the reproducing apparatus is invalidated.

The 8^{th} aspect of the present invention is the content protecting method according to the 7^{th} aspect of the present invention, wherein,

in the decryption key returning step, when the viewing expiration time lapses during the reproduction of the content even if the predetermined event does not occur, the decryption key on the reproducing apparatus is invalidated.

The 9^{th} aspect of the present invention is the content protecting method according to the 8^{th} aspect of the present invention, wherein,

even when the viewing expiration time lapses during the reproduction of the content, a decrypting and reproducing operation is continuously performed until the reproducing operation for the content ends.

The 10^{th} aspect of the present invention is the content protecting method according to the 1^{st} aspect of the present invention, wherein, when the viewing expiration time information represents a length of viewable time from a first viewing start point, the reproducing apparatus converts the length of the time into a reproducibility end time with reference to a usable time source.

The 11^{th} aspect of the present invention is the content protecting method according to the 1^{st} aspect of the present invention, wherein,

when the reproducing apparatus cannot read out the viewing expiration time information from the recording medium or the read-out viewing expiration time information cannot be used, the content is deleted from the recording medium or the content is not deleted from the recording medium and is not presented to a user as a reproduction target content.

The 12^{th} aspect of the present invention is a content reproducing apparatus in which a recording medium having recorded thereon an encrypted content involving viewing expiration time information and a decryption key for decrypting the content is inserted,

the content reproducing apparatus comprising:

an event detecting unit which detects occurrence of a predetermined event;

a viewing expiration time determining unit which determines, by comparing the viewing expiration time information with current time, whether the viewing expiration time has lapsed;

a decryption key temporary storage unit which temporarily stores the decryption key;

a decryption key moving unit which moves the decryption key from the recording medium to the decryption key temporary storage unit and returns the decryption key moved to the decryption key temporary storage unit onto the recording medium;

a content protection control unit which controls the movement and the return of the decryption key; and

a content reproducing unit which decrypts the content using the decryption key and reproduces the content, wherein

the content protection control unit moves, using a determination result of the viewing expiration time determining unit and a detection result of the event detecting unit, the decryption key from the recording medium to the decryption key temporary storage unit with the decryption key moving unit from a time when the recording medium is inserted until the viewing expiration time lapses or until a predetermined period elapses after the viewing expiration time and, when the occurrence of the predetermined event is detected, performs control to return the decryption key onto the recording medium with the decryption key moving unit if the viewing expiration time has not lapsed or the predetermined period has not elapsed after the viewing expiration time and to not return the decryption key onto the recording medium if the viewing expiration time has lapsed or the predetermined period has elapsed after the viewing expiration time.

The 13^{th} aspect of the present invention is the content reproducing apparatus according to the 12^{th} aspect of the present invention, wherein

the content protection control unit moves the decryption key with the decryption key moving unit when the content reproducing unit starts the reproduction of the content.

The 14^{th} aspect of the present invention is the content reproducing apparatus according to the 12^{th} aspect of the present invention, wherein

the content protection control unit moves the decryption key with the decryption key moving unit when it is determined by the viewing expiration time determining unit that the viewing expiration time has lapsed or the predetermined period has elapsed after the viewing expiration time.

The 15^{th} aspect of the present invention is the content reproducing apparatus according to the 12^{th} aspect of the present invention, wherein

the content protection control unit invalidates the decryption key of the recording medium with the decryption key moving unit when the viewing expiration time has lapsed or the predetermined period has elapsed after the viewing expiration time instead of moving the decryption key from the recording medium to the decryption key temporary storage unit with the decryption key moving unit.

The 16^{th} aspect of the present invention is the content reproducing apparatus according to the 12^{th} aspect of the present invention, wherein

the predetermined event means that the content reproducing unit completes reproducing operation for the content, the recording medium is removed from the content reproducing apparatus after the completion of the reproducing operation, or a reproduction suspension instruction is received while the content reproducing unit reproduces the content.

The 17^{th} aspect of the present invention is the content reproducing apparatus according to the 12^{th} aspect of the present invention, wherein

the content protection control unit invalidates the decryption key stored in the decryption key temporary storage unit with the decryption key moving unit if the viewing expiration time has lapsed when the occurrence of the predetermined event is detected by the event detecting unit.

The 18^{th} aspect of the present invention is the content reproducing apparatus according to the 17^{th} aspect of the present invention, wherein

the content protection control unit invalidates the decryption key stored in the decryption key temporary storage unit with the decryption key moving unit when it is detected by the viewing expiration time determining unit that the viewing expiration time has lapsed while the content reproducing unit reproduces the content even if the occurrence of the predetermined event is not detected by the event detecting unit.

The 19^{th} aspect of the present invention is the content reproducing apparatus according to the 18^{th} aspect of the present invention, wherein the content reproducing unit continuously performs a decrypting and reproducing operation until the reproducing operation for the content ends even when it is determined that the viewing expiration time has lapsed during the reproduction of the content.

The 20^{th} aspect of the present invention is the content reproducing apparatus according to the 12^{th} aspect of the present invention, wherein,

when the viewing expiration time information represents a length of viewable time from a first viewing start point, the viewing expiration time determining unit converts the length of the time into a reproducibility end time using the current time.

The 21^{st} aspect of the present invention is the content reproducing apparatus according to the 12^{th} aspect of the present invention, wherein,

when the viewing expiration time information cannot be read out from the recording medium or the read-out viewing expiration time information cannot be used, the content protection control unit performs control to delete the content from the recording medium or to not delete the content from the recording medium and not present the content to a user as a reproduction target content.

The 22^{nd} aspect of the present invention is a program embodied on a non-transitory and tangible computer-readable medium, the program causing a computer to execute a content protecting method when a recording medium in which an encrypted content involving a viewing expiration time and a decryption key for decrypting the content were recorded is inserted into a reproducing apparatus,

the content protecting method comprising:

a decryption key evacuation step of moving the decryption key from the recording medium onto the reproducing apparatus, from a time when the recording medium is inserted into the reproducing apparatus until the viewing expiration time lapses or until a predetermined period elapses after the viewing expiration time; and

a decryption key returning step of, when a predetermined event occurs, returning the decryption key onto the recording medium when the viewing expiration time has not lapsed or the predetermined period has not elapsed after the viewing expiration time and not returning the decryption key onto the recording medium when the viewing expiration time has lapsed or the predetermined period has elapsed after the viewing expiration time.

According to the present invention, it is possible to provide a content reproducing apparatus, a content protecting method, and the like which can prevent, when a viewing expiration time has lapsed during reproduction of content with viewing expiration time recorded on a recording medium, malicious analysis and wrong reproduction even if the recording medium is removed from a reproducing apparatus.

### BRIEF DESCRIPTION OF THE DRAWINGS

FIG. 1 is a block diagram of a content download system according to a first embodiment of the present invention.

FIG. 2 is a block diagram of a player which reproduces content with viewing expiration time according to the first embodiment of the present invention.

FIG. 3 is a flowchart showing a processing flow in reproducing content with viewing expiration time on an SD card in the player according to the first embodiment of the present invention.

FIG. 4 is a block diagram of a conventional content download system.

FIG. 5 is a block diagram of a conventional player which reproduces content with viewing expiration time.

### REFERENCE SIGNS LIST

100 player
101 clock
102 SD card
103 encrypted content
104 title key
105 viewing expiration time information
106 title key storing unit
107 viewing expiration time determining unit
108 content decrypting unit
109 decoder
110 AV output
111 key moving unit
112 reproduction control unit
115 encrypted content
200 player
201 key readout unit
300 reproduction control unit
301 viewing expiration time determining unit
302 content protection control unit
303 instruction input unit
304 card insertion detecting unit
305 content decrypting unit
500 content server
501 DRM server
502 content receiver
505 content key
507 DRM decrypting unit
508 CPS encrypting unit
509 viewing condition converting unit
600 viewing expiration time information

### DETAILED DESCRIPTION

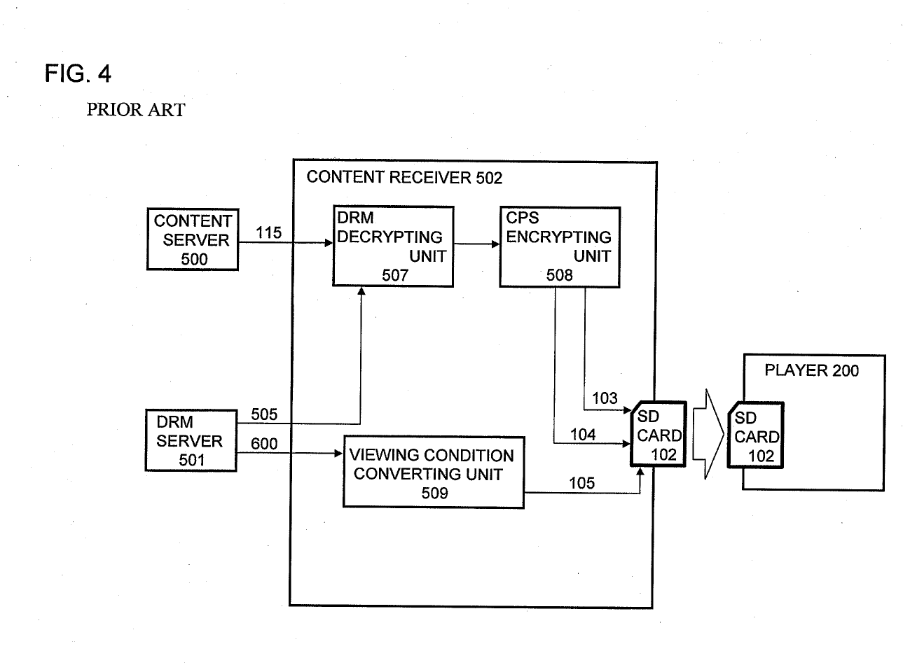

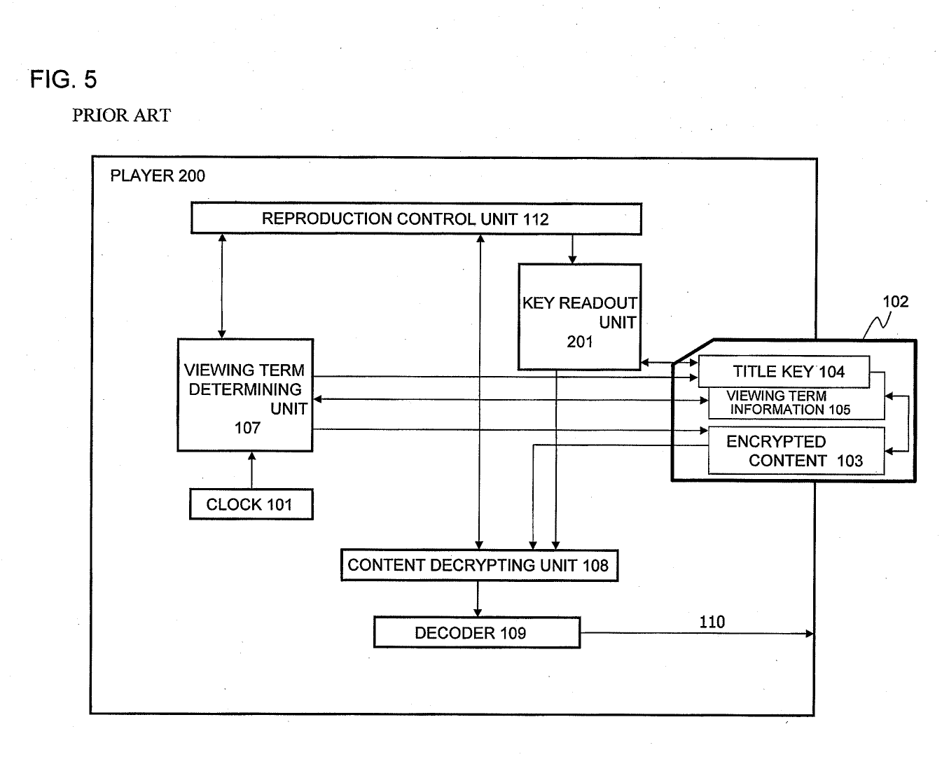

Embodiments of the present invention are explained below with reference to the drawings. In the following explanation, components having the same functions as those of the conventional example shown in FIGS. 4 and 5 are denoted by the same reference numerals and signs and explanation of the components is omitted.

### First Embodiment

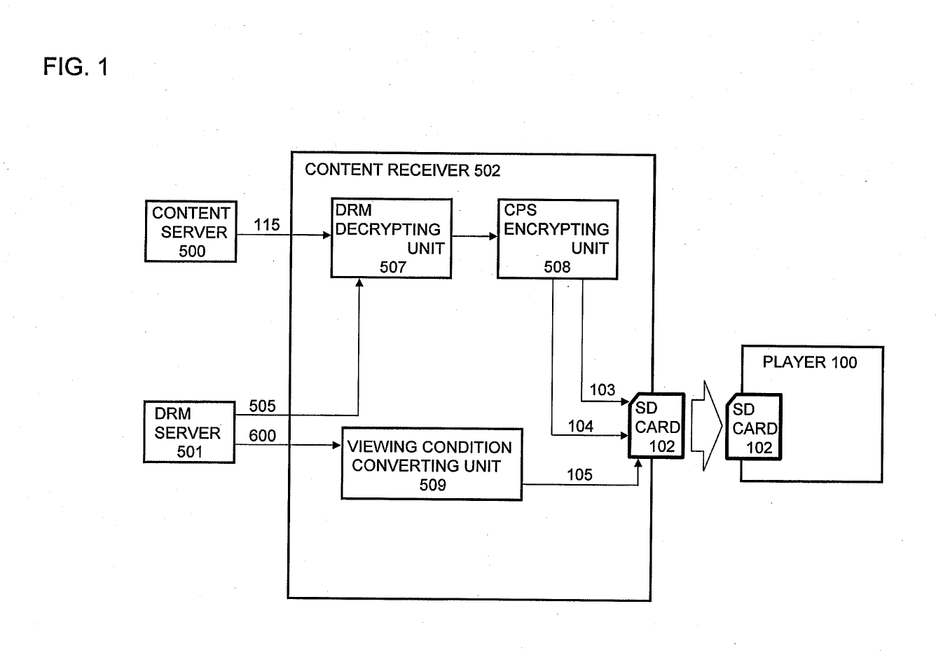

A block diagram of a content download system according to a first embodiment of the present invention is shown in FIG. 1.

A method of downloading content from the content server 500 and a method of recording content downloaded by the content receiver 502 in the SD card 102 for viewing in another content player are the same as those of the conventional content download system explained with reference to FIG. 4.

A reproduction method of a player 100 which reproduces content in the SD card 102 in which downloaded content is recorded by the content receiver 502 is different from the reproduction method by the player 200 in the conventional example explained with reference to FIG. 5.

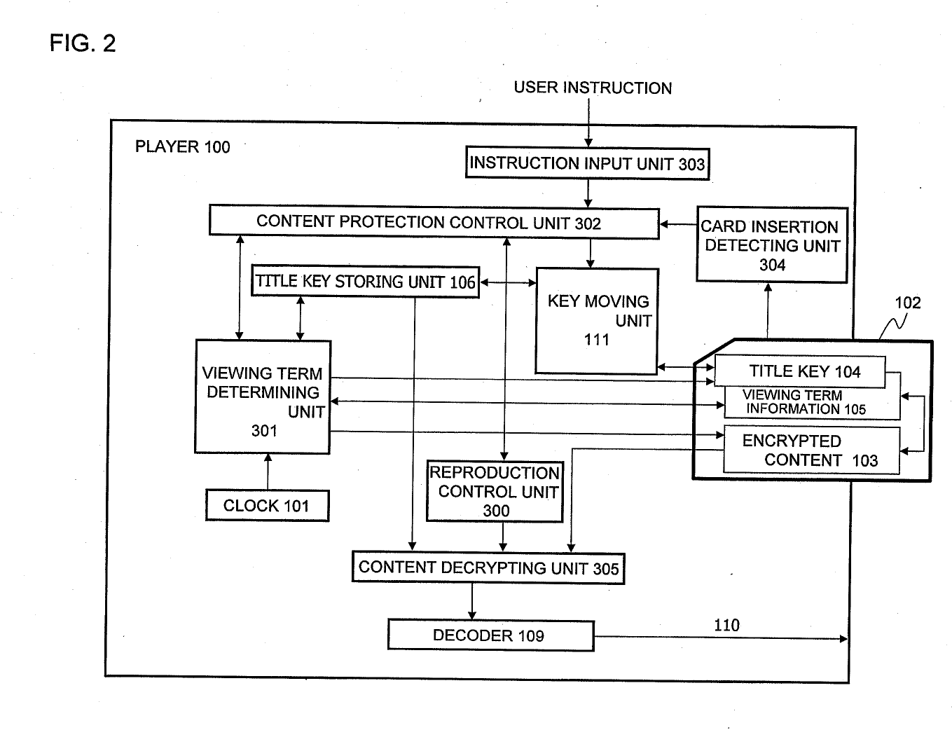

FIG. 2 is a block diagram of a player for content with viewing expiration time according to the first embodiment.

As explained in the conventional example, the content 103 encrypted in the CPRM format by the content receiver 502, the title key 104 used for decryption of the encrypted content 103, and the viewing expiration time information 105 converted into the CPS format are recorded in the SD card 102 which is inserted into the player 100 according to the first embodiment.

The player 100 corresponds to an example of a reproducing apparatus according to the present invention. The SD card 102 corresponds to an example of a recording medium according to the present invention. The title key 104 corresponds to an example of a decryption key according to the present invention.

A viewing expiration time determining unit 301 compares the viewing expiration time information 105 on the SD card 102 with time information (current time) obtained by the clock 101 to thereby determine whether a viewing expiration time for the encrypted content 103 has lapsed.

A title key storing unit 106 is a recording medium which temporarily stores the title key 104 on the SD card 102 in the player 100 and is, for example, a RAM.

A key moving unit 111 moves the title key 104 on the SD card 102 to the title key storing unit 106 and writes back the title key 104 temporarily stored in the title key storing unit 106 onto the SD card 102 according to the control by a content protection control unit 302.

The key moving unit 111 corresponds to an example of a decryption key moving unit according to the present invention. The title key storing unit 106 corresponds to an example of a decryption key temporary storage unit according to the present invention. The clock 101 corresponds to an example of a usable time source according to the present invention.

Instructions from the user such as a reproduction start instruction and a reproduction stop instruction for content are input to an instruction input unit 303. For example, these instructions are input by a remote controller.

A card insertion detecting unit 304 detects that the SD card 102 is inserted into the player 100 and the inserted SD card 102 is removed from the player 100.

A reproduction control unit 300 controls a content decrypting unit 305 to decrypt the encrypted content 103 using the title key 104 stored in the title key storing unit 106. The content decrypting unit 305 outputs plaintext content, which is a result of decrypting the encrypted content 103, to the decoder 109. The decoder 109 converts the input plaintext content into an AV signal and outputs the AV signal as the AV output 110.

A configuration including the reproduction control unit 300, the content decrypting unit 305, and the decoder 109 corresponds to an example of a content reproducing unit according to the present invention.

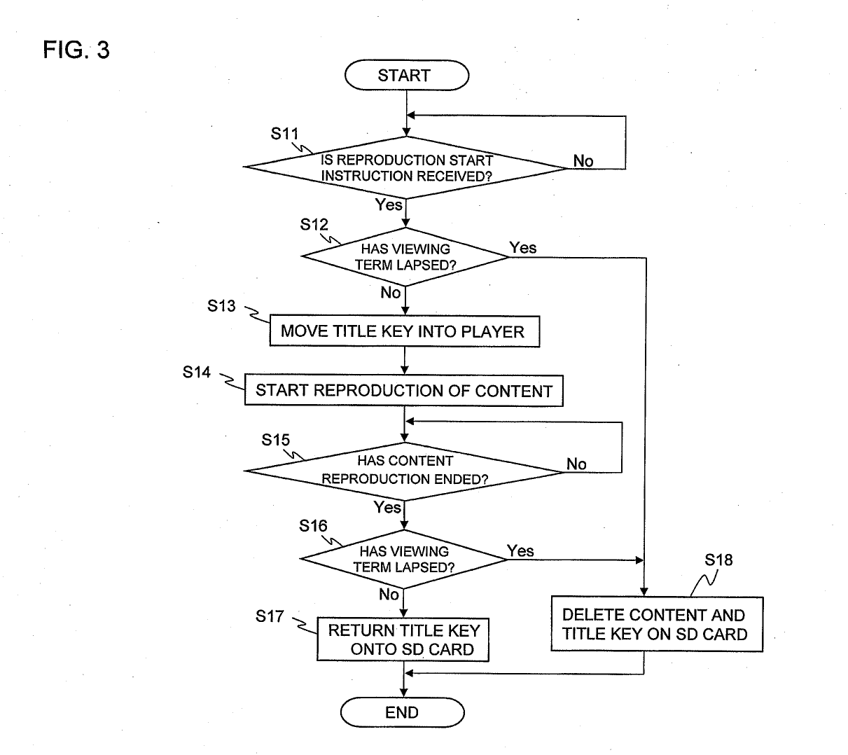

Next, a method of reproducing content with viewing expiration time in the player 100 according to the first embodiment is explained with reference to FIGS. 2 and 3.

FIG. 3 shows a processing flow in the player 100 in reproducing the encrypted content 103 with viewing expiration time recorded in the SD card 102.

When a content reproduction start instruction from the user is input to the instruction input unit 303, the instruction is notified to the content protection control unit 302 (step S11).

When the content protection control unit 302 receives the content reproduction start instruction from the user, the content protection control unit 302 instructs the viewing expiration time determining unit 301 to read the viewing expiration time information 105, which is the viewing expiration time of the encrypted content 103, from the SD card 102 and compare the viewing expiration time information 105 with time information obtained from the clock 101 to thereby determine the lapse of the viewing expiration time (step S12).

The viewing expiration time determining unit 301, which has received this instruction, returns a result of the determination concerning the lapse of the viewing expiration time to the content protection control unit 302 and, when the viewing expiration time has lapsed, deletes the encrypted content 103, the title key 104, and the viewing expiration time information 105 from the SD card 102 (step S18).

When the viewing expiration time has not lapsed, the content protection control unit 302, which has received the determination result of the viewing expiration time determining unit 301, instructs the key moving unit 111 to move the title key 104 from the SD card 102 to the title key storing unit 106 (step S13) and instructs the reproduction control unit 300 to start reproduction of the content.

The processing in step S13 for moving the title key 104 to the title key storing unit 106 corresponds to an example of a decryption key evacuation step according to the present invention.

The reproduction control unit 300, which has received this instruction, causes the content decrypting unit 305 to start decryption of the encrypted content 103 on the SD card 102 (step S14).

When instructed to start decryption by the reproduction control unit 300, the content decrypting unit 305 reads out the title key 104 from the title key storing unit 106, decrypts the encrypted content 103 read out from the SD card 102 using the title key 104, and outputs plaintext content, which is a result of the decryption, to the decoder 109. The decoder 109 converts the plaintext content output from the content decrypting unit 305 into an AV signal and outputs the AV signal as the AV output 110.

Until a reproduction stop instruction from the user is input to the instruction input unit 303 or until the content reproduction reaches the end of the content and the reproduction of the content is stopped, the decryption processing by the content decrypting unit 305 and the decode processing by the decoder 109 are continued and the AV output 110 is continuously output (step S15).

When the content reproduction reaches the end, the reproduction control unit 300 notifies the content protection control unit 302 that the content reproduction reaches the end. The content protection control unit 302 instructs the viewing expiration time determining unit 301 to determine whether the viewing expiration time of the encrypted content 103 has lapsed at that point (step S16).

When the viewing expiration time has not lapsed at this point, the content protection control unit 302, which has received the determination result of the viewing expiration time determining unit 301, instructs the key moving unit 111 to write back the title key 104 stored on the title key storing unit 106 onto the SD card 102 (step S17).

This processing in step S17 for returning, with the key moving unit 111, the title key 104 onto the SD card 102 corresponds to an example of a decryption key returning step according to the present invention.

On the other hand, when the viewing expiration time has lapsed at this point, the content protection control unit 302 instructs the key moving unit 111 to delete the title key 104 stored on the title key storing unit 106 without writing back the title key 104 onto the SD card 102. At this point, the viewing expiration time determining unit 301 deletes the encrypted content 103 and the viewing expiration time information 105 from the SD card 102 (step S18).

When the reproduction stop instruction from the user to the instruction input unit 303 is input in step S15, the processing in step S16 explained above same as the processing performed when the content reproduction reaches the end is performed.

The reaching of the content reproduction to the end in step S15 corresponds to an example of completing reproduction operation for content according to the present invention. The inputting of the reproduction stop instruction from the user to the instruction input unit 303 corresponds to an example of receiving a reproduction suspension instruction during reproduction of content.

It is evident what kind of state occurs when a malicious user removes the SD card 102 without a reproduction stop instruction during the reproduction of the content (step S15). Specifically, since the SD card 102 is removed from the player 100 while write-back processing for the title key 104 by the key moving unit 111 is not performed, the title key 104 is not present on the removed SD card 102. Therefore, even if a malicious user attempts to analyze recorded data on the SD card 102 and illegally decrypt the encrypted content 103 in this case, since the title key 104 is not present on the SD card 102, the decryption cannot be performed.

In the first embodiment, operation performed when the viewing expiration time has lapsed during content viewing is not mentioned. However, the title key 104 stored on the title key storing unit 106 may be deleted at a point when the viewing expiration time has lapsed. Since the content decrypting unit 305 can also continue the decrypting operation in this case, it goes without saying that the same effect can be obtained.

In the first embodiment, when the viewing expiration time has not lapsed when the reproduction stop instruction from the user is input, the title key 104 is written back onto the SD card 102 by the key moving unit 111. However, when the viewing expiration time has not lapsed when the reproduction stop instruction from the user is not input and the SD card 102 is removed, the card insertion detecting unit 304 detects that the SD card 102 is removed. The title key 104 is written back onto the SD card 102 immediately before the SD card 102 is actually removed.

In the first embodiment, the title key 104 on the SD card 102 is moved to the title key storing unit 106 when the reproduction start instruction from the user is input. Rather than when the reproduction start instruction from the user is input, when the reproduction control unit 300 causes the content decrypting unit 305 to start decryption of the encrypted content 103 (step S14), the content protection control unit 302 may move the title key 104 to the title key storing unit 106 according to a determination result from the viewing expiration time determining unit 301 or may perform the processing for deleting the encrypted content 103, the title key 104, and the viewing expiration time information 105 from the SD card 102.

The determination concerning the lapse of the viewing expiration time may be performed at both timing when the reproduction start instruction from the user is input and timing when the decrypting unit 305 is caused to start decryption. In this case, when the viewing expiration time has not lapsed when the reproduction start instruction is input but the viewing expiration time has lapsed when the decryption is started, the title key 104 is moved to the title key storing unit 106 when the reproduction start instruction is input and, when the decryption is started, the encrypted content 103 and the viewing expiration time information 105 are deleted from the SD card 102. Therefore, in this case, since the encrypted content 103 is deleted before the decryption is started, the decryption is not performed and the processing is ended without reproducing the encrypted content 103.

Both the timing when the reproduction start instruction from the user is input and the timing when the decryption is started correspond to an example of timing when reproduction is started according to the present invention.

The title key 104 may be moved not only at the timings when the reproduction is started but also at arbitrary timing until the reproduction start instruction from the user is input after the card insertion detecting unit 304 detects that the SD card 102 is inserted. The title key 104 may be moved after the reproduction of the encrypted content 103 is started. When the title key 104 is moved after the reproduction of the encrypted content 103 is started, the title key 104 only has to be moved by the time when the content reproduction reaches the viewing expiration time or by the time when a predetermined period elapses after the viewing expiration time. The predetermined period in this case is a period determined in advance such as three seconds or ten seconds. The title key 104 only has to be moved by the time when three seconds elapse after the viewing expiration time or by the time when ten seconds elapse after the viewing expiration time. When the title key 104 is moved after the reproduction of the encrypted content is started, the content decrypting unit 305 starts the decryption of the encrypted content 103 using the title key 104 on the SD card 102 rather than the title key 104 stored in the title key storing unit 106.

The content protection control unit 302 may cause the key moving unit 111 to delete the title key 104 on the SD card 102 when the content reproduction reaches the viewing expiration time or when the predetermined period elapses after the viewing expiration time rather than moving the title key 104 on the SD card 102 to the title key storing unit 106. In this case, since the content decrypting unit 305 can continue the decrypting operation, an effect same as that explained above can be obtained.

In the first embodiment, in step S13, the title key 104 on the SD card 102 is moved to the title key storing unit 106 by the key moving unit 111. Specifically, the title key 104 on the SD card 102 is copied to the title key storing unit 106 and the title key 104 on the SD card 102 is deleted. However, instead of “moving” the title key 104 in this way, the title key 104 on the SD card 102 may be copied to the title key storing unit 106 and the title key 104 on the SD card 102 may be changed to an undecryptable state, an unreadable state, or the like to invalidate the title key 104 on the SD card 102. In step S17, instead of writing back the title key 104 onto the SD card 102, the title key 104 on the SD card 102 may be changed to a decryptable state, a readable state, or the like to validate and return the title key 104 on the SD card 102.

“Invalidate” includes deletion of the title key 104 on the SD card 102 and “validate” includes re-recording (write back) of the title key 104 once deleted from the SD card 102.

In the present invention, “moving the decryption key” means copying the title key 104 on the SD card 102 to the title key storing unit 106 and invalidating the title key 104 on the SD card 102. “Returning the decryption key” means validating the invalidated title key 104 on the SD card 102.

In the first embodiment, in step S17 and step S18, the title key 104 stored in the title key storing unit 106 is deleted. However, at this point, the key moving unit 111 may change the title key 104 stored in the title key storing unit 106 to the undecryptable state or the unreadable state to invalidate the title key 104 rather than deleting the title key 104. Further, at this point, the key moving unit 111 may leave the title key 104 stored in the title key storing unit 106 without applying processing such as deletion to the title key 104.

In the first embodiment, the example in which the viewing expiration time information 105 is the time information is explained. However, the viewing expiration time is not limited to this. It goes without saying that, when the viewing expiration time information 105 represents the length of viewable time from a point when the reproduction of the encrypted content 103 is started first, the same effect can be obtained if date and time obtained by adding the length of the viewable time to clock information in reproducing the encrypted content 103 first is used as the viewing expiration time information 105 anew. In this case, when the viewing expiration time information 105 is written back onto the SD card 102 in step S17, the length of the viewable time is converted into viewable date and time information.

In the first embodiment, operation performed when the maliciously removed SD card 102 is inserted into the player 100 is not explained. However, it goes without saying that analysis of an ill will can be more surely prevented if the player 100, which detects the presence of the encrypted content 103 without the presence of the title key on the inserted SD card 102, deletes the content 103.

In the first embodiment, the process of reading and writing of the title key 104 on the SD card 102 is explained in the simplified manner. However, it goes without saying that the same effect can be obtained even in a form in which the title key 104 is stored in an authentication area on the SD card 102 and reading and writing of the title key 104 from and to the player 100 cannot be performed unless authentication of the player 100 and the SD card 102 is successful.

In the first embodiment, the SD card 102 is used as an example of the recording medium in which an encrypted content is recorded and from which the encrypted content is moved. However, the recording medium only has to be a rewritable and detachable recording medium. A memory card other than the SD card, a DVD-RAM, and the like can be used as the recording medium of the present invention.

The processing in the viewing expiration time determining unit 301, the content protection control unit 302, the key moving unit 111, the reproduction control unit 300, and the like can be performed by causing a CPU or the like, which controls the player 100, to execute a program and using software. In particular, by causing a program to execute the processing in these units, it is possible to easily change the method of protecting content such as a change of timing for moving a title key.

A program according to the present invention is a program for causing a computer to execute the operation of the decryption key evacuation step for moving the decryption key from the recording medium onto the reproducing apparatus and the decryption key returning step for returning the decryption key onto the recording medium unless the viewing expiration time has lapsed or the predetermined period has elapsed after the viewing expiration time when a predetermined event occurs of the method of protecting content and is a program which operates in cooperation with the computer.

The “operation of the steps” according to the present invention means the operation of all or a part of the steps.

A form of use of the program according to the present invention may be a form in which the program is recorded on a recording medium such as a ROM readable by a computer and operates in cooperation with the computer.

A form of use of the program according to the present invention may be a form in which the program is transmitted through a transmission medium such as the Internet or a transmission medium such as light or a radio wave, read by a computer, and operates in cooperation with the computer.

The computer according to the present invention explained above is not limited to pure hardware such as a CPU and may include firmware, an OS, and peripheral equipment.

As explained above, the configuration of the present invention may be realized in terms of software or may be realized in terms of hardware.

### INDUSTRIAL APPLICABILITY

The content reproducing apparatus, the method of protecting content, and the like according to the present invention have an effect that, when a viewing expiration time has lapsed during reproduction of content with viewing expiration time recorded on a recording medium, malicious analysis and wrong reproduction can be prevented even if the recording medium is removed from the reproducing apparatus and are useful as a content reproducing apparatus, a method of protecting content, and the like for encrypted content written in a detachable recording medium together with viewing expiration time information.

What is claimed is:

1. A content protecting method when a recording medium in which an encrypted content involving a viewing expiration time and a decryption key for decrypting the content were recorded is inserted into a reproducing apparatus,
the content protecting method comprising:
a decryption key evacuation step of moving the decryption key from the recording medium onto the reproducing apparatus, from a time when the recording medium is inserted into the reproducing apparatus until the viewing expiration time lapses or until a predetermined period elapses after the viewing expiration time; and
a decryption key returning step of, when a predetermined event occurs, returning the decryption key onto the recording medium when the viewing expiration time has not lapsed or the predetermined period has not elapsed after the viewing expiration time and not returning the decryption key onto the recording medium when the viewing expiration time has lapsed or the predetermined period has elapsed after the viewing expiration time.

2. The content protecting method according to claim 1, wherein
the moving of the decryption key is copying the decryption key on the recording medium onto the reproducing apparatus and invalidating the decryption key on the recording medium, and
the returning of the decryption key is validating the invalidated decryption key on the recording medium.

3. The content protecting method according to claim 1, wherein,
in the decryption key evacuation step, the movement of the decryption key is executed when reproduction of the content is started.

4. The content protecting method according to claim 1, wherein,
in the decryption key evacuation step, the movement of the decryption key is executed when the viewing expiration time lapses or the predetermined period elapses after the viewing expiration time.

5. The content protecting method according to claim 1, wherein,
in the decryption key evacuation step, instead of performing the movement of the decryption key, the decryption key of the recording medium is invalidated when the viewing expiration time lapses or the predetermined period elapses after the viewing expiration time.

6. The content protecting method according to claim 1, wherein
the predetermined event means that reproducing operation for the content is completed, the recording medium is removed from the reproducing apparatus after the completion of the reproducing operation, or a reproduction suspension instruction is received during the reproduction of the content.

7. The content protecting method according to claim 1, wherein,
in the decryption key returning step, if the viewing expiration time has lapsed when the predetermined event occurs, the decryption key on the reproducing apparatus is invalidated.

8. The content protecting method according to claim 7, wherein,
in the decryption key returning step, when the viewing expiration time lapses during the reproduction of the content even if the predetermined event does not occur, the decryption key on the reproducing apparatus is invalidated.

9. The content protecting method according to claim 8, wherein,
even when the viewing expiration time lapses during the reproduction of the content, a decrypting and reproducing operation is continuously performed until the reproducing operation for the content ends.

10. The content protecting method according to claim 1, wherein,
when the viewing expiration time information represents a length of viewable time from a first viewing start point, the reproducing apparatus converts the length of the time into a reproducibility end time with reference to a usable time source.

11. The content protecting method according to claim 1, wherein,
when the reproducing apparatus cannot read out the viewing expiration time information from the recording medium or the read-out viewing expiration time information cannot be used, the content is deleted from the recording medium or the content is not deleted from the recording medium and is not presented to a user as a reproduction target content.

12. A content reproducing apparatus in which recording medium having recorded thereon an encrypted content involving viewing expiration time information and a decryption key for decrypting the content is inserted,
the content reproducing apparatus comprising:
an event detecting unit which detects occurrence of a predetermined event;
a viewing expiration time determining unit which determines, by comparing the viewing expiration time information with current time, whether the viewing expiration time has lapsed;
a decryption key temporary storage unit which temporarily stores the decryption key;
a decryption key moving unit which moves the decryption key from the recording medium to the decryption key temporary storage unit and returns the decryption key moved to the decryption key temporary storage unit onto the recording medium;
a content protection control unit which controls the movement and the return of the decryption key; and
a content reproducing unit which decrypts the content using the decryption key and reproduces the content, wherein
the content protection control unit moves, using a determination result of the viewing expiration time determining unit and a detection result of the event detecting unit, the decryption key from the recording medium to the decryption key temporary storage unit with the decryption key moving unit from a time when the recording medium is inserted until the viewing expiration time lapses or until a predetermined period elapses after the viewing expiration time and, when the occurrence of the predetermined event is detected, performs control to return the decryption key onto the recording medium with the decryption key moving unit if the viewing expiration time has not lapsed or the predetermined period has not elapsed after the viewing expiration time and to not return the decryption key onto the recording medium if the viewing expiration time has lapsed or the predetermined period has elapsed after the viewing expiration time.

13. The content reproducing apparatus according to claim 12, wherein
the content protection control unit moves the decryption key with the decryption key moving unit when the content reproducing unit starts the reproduction of the content.

14. The content reproducing apparatus according to claim 12, wherein
the content protection control unit moves the decryption key with the decryption key moving unit when it is determined by the viewing expiration time determining unit that the viewing expiration time has lapsed or the predetermined period has elapsed after the viewing expiration time.

15. The content reproducing apparatus according to claim 12, wherein
the content protection control unit invalidates the decryption key of the recording medium with the decryption key moving unit when the viewing expiration time has lapsed or the predetermined period has elapsed after the viewing expiration time instead of moving the decryption key from the recording medium to the decryption key temporary storage unit with the decryption key moving unit.

16. The content reproducing apparatus according to claim 12, wherein
the predetermined event means that the content reproducing unit completes reproducing operation for the content, the recording medium is removed from the content reproducing apparatus after the completion of the reproducing operation, or a reproduction suspension instruction is received while the content reproducing unit reproduces the content.

17. The content reproducing apparatus according to claim 12, wherein
the content protection control unit invalidates the decryption key stored in the decryption key temporary storage unit with the decryption key moving unit if the viewing expiration time has lapsed when the occurrence of the predetermined event is detected by the event detecting unit.

18. The content reproducing apparatus according to claim 17, wherein
the content protection control unit invalidates the decryption key stored in the decryption key temporary storage unit with the decryption key moving unit when it is detected by the viewing expiration time determining unit that the viewing expiration time has lapsed while the content reproducing unit reproduces the content even if the occurrence of the predetermined event is not detected by the event detecting unit.

19. The content reproducing apparatus according to claim 18, wherein
the content reproducing unit continuously performs a decrypting and reproducing operation until the reproducing operation for the content ends even when it is determined that the viewing expiration time has lapsed during the reproduction of the content.

20. The content reproducing apparatus according to claim 12, wherein,
when the viewing expiration time information represents a length of viewable time from a first viewing start point, the viewing expiration time determining unit converts the length of the time into a reproducibility end time using the current time.

21. The content reproducing apparatus according to claim 12, wherein,
when the viewing expiration time information cannot be read out from the recording medium or the read-out viewing expiration time information cannot be used, the content protection control unit performs control to delete the content from the recording medium or to not delete the content from the recording medium and not present the content to a user as a reproduction target content.

22. A program embodied on a non-transitory and tangible computer-readable medium, the program causing a computer to execute a content protecting method when a recording medium in which an encrypted content involving a viewing expiration time and a decryption key for decrypting the content were recorded is inserted into a reproducing apparatus,
the content protecting method comprising:
a decryption key evacuation step of moving the decryption key from the recording medium onto the reproducing apparatus, from a time when the recording medium is inserted into the reproducing apparatus until the viewing expiration time lapses or until a predetermined period elapses after the viewing expiration time; and
a decryption key returning step of, when a predetermined event occurs, returning the decryption key onto the recording medium when the viewing expiration time has not lapsed or the predetermined period has not elapsed after the viewing expiration time and not returning the decryption key onto the recording medium when the viewing expiration time has lapsed or the predetermined period has elapsed after the viewing expiration time.
